(19) United States
(12) Patent Application Publication
(10) Pub. No.: US 2010/0302029 A1
(43) Pub. Date: Dec. 2, 2010

(54) TRANSMISSION OF AN EMERGENCY CALL FROM A MOTOR CYCLE

(75) Inventors: Andreas Emmerich, Oberursel (DE); Thomas Bauer, Frankfurt am Main (DE); James Remfrey, Neu-Anspach (DE)

Correspondence Address: RATNERPRESTIA, P.O. BOX 980, VALLEY FORGE, PA, 19482, US

(73) Assignee: Continental Teves Ag & Co. oHG, Frankfurt (DE)

(21) Appl. No.: 12/599,867

(22) PCT Filed: May 13, 2008
(86) PCT No.: PCT/EP2008/055856

§ 371 Date: Jan. 29, 2010

(30) Foreign Application Priority Data
May 30, 2007 (DE) 10 2007 025 270.8
May 13, 2008 (DE) 10 2008 023 243.2

(51) Int. Cl. G08B 1/08

(52) U.S. Cl. 340/539.13

(57) ABSTRACT

A control unit determines whether an accident of a motorcycle has occurred in that corresponding measurement data from a sensor system are analyzed. Following this, a fully automatic emergency call is emitted. The emergency call is transmitted via a voice channel after the emergency call data have been subjected to a media conversion.

### CROSS REFERENCE TO RELATED APPLICATIONS

This application is the U.S. national phase application of PCT International Application No. PCT/EP2008/055856, filed May 13, 2008, which claims priority to German Patent Application No. 10 2007 025 270.8, filed May 30, 2007 and German Patent Application No. 10 2008 023 243.2, filed May 13, 2008, the contents of such applications being incorporated by reference herein.

### BACKGROUND OF THE INVENTION

1. Field of the Invention

The invention relates to the emergency call and safety technology for motorcycles. In particular, the invention relates to an emergency call facility for a motorcycle for transmitting an emergency call, to an emergency call system for a motorcycle, the use of an emergency call facility in a motorcycle, a method, a program element and a computer-readable medium.

2. Description of the Related Art

Passenger car emergency radio systems enable position data of the accident-afflicted vehicle to be transmitted to an emergency call center. From DE 299 11 590 U1, a device triggering the emergency call by airbag sensors and permanently installed in a passenger car is known. The device has a hands-free telephone by means of which the center can establish contact with the vehicle rider. The emergency call takes place automatically when one of the airbags located in the passenger car is triggered.

This device is provided for cars and not for use in motorcycles.

### SUMMARY OF THE INVENTION

It is an object of the invention to provide an automatable transmission of emergency calls from a motorcycle.

Specified are an emergency call facility for a motorcycle for transmitting an emergency call, an emergency call system, the use, a method, a program element and a computer-readable medium.

The exemplary embodiments described equally relate to the emergency call facility, the emergency call system, the use, the method, the program element and the computer-readable medium.

According to an exemplary embodiment of the invention, an emergency call facility for a motor cycle for transmitting an emergency call is specified, the emergency call facility exhibiting a detection unit for detecting measurement data, a control unit for analyzing the measurement data and for deciding whether an accident of the motor cycle has occurred, a position finding unit for determining a position of the motor cycle, and a communication unit for transmitting an emergency call to a receiver when the analysis of the measurement data shows that an accident has occurred. In this arrangement, the emergency call contains the determined position of the motor cycle.

In other words, the emergency call facility is capable of detecting by an analysis of the measurement data that an accident has occurred. For this purpose, for example, measurement data are analyzed which are conducted to the control unit from a position sensor for detecting an angle of inclination of the motor cycle. In addition or as an alternative thereto, data from an acceleration sensor for detecting an acceleration of the motorcycle can be used, and speed data which are measured by a speed sensor.

In particular, the history of the detected data can be evaluated. If, for example, an extremely strong (negative) acceleration has occurred and the speed of the motorcycle has thereupon dropped to zero, the control unit could conclude that an accident has occurred. A further possibility is that the position sensor determines that the motorcycle is lying flat on the ground or assuming an unnatural angle to the horizontal which does not correspond to a normal driving state of the motorcycle. In this case, too, the control unit can conclude that an accident has occurred.

As well, for example, temperature sensors can be provided which measure a current temperature at a particular point at or in the motorcycle. If a particular threshold temperature is exceeded, it can be concluded that a malfunction or even an outbreak of a fire has occurred.

As well, a sensor system can be provided which measures whether the rider is still on the motorcycle. For this purpose, it is possible, for example, to provide touch sensors or pressure sensors on the steering wheel and on the seat and/or the foot pedals. If the rider is thrown from the motorcycle during an accident, this process is detected by the sensors. If the speed of the motorcycle has then dropped to zero at a later time and/or the motorcycle assumes an unnatural angle, the control unit can conclude that an accident of the motorcycle has occurred.

Other combinations of sensor data (measurement data) which are taken into consideration in the analysis are also possible.

The analyzed and evaluated measurement data can be sent together with the emergency call (if necessary after appropriate editing). This enables the emergency services to obtain more accurate information about the accident event. Thus, for example, the emergency services can determine the gravity of the accident (for example by determining the strength of the acceleration forces which have occurred) or whether, for example, a fire has developed (by evaluating the temperature data).

In this manner, the initiation of appropriate rescue measures can be optimized, as a result of which ultimately a faster and more effective rescue operation can be guaranteed.

For example, the motorcyclist and possibly also the passenger can carry a cableless sensor or direction finder (which is integrated, e.g. in his jacket or trousers). This sensor sends a signal to the control unit from which it is possible to conclude the current location of the rider or passenger. The rider or passenger can be found rapidly by the emergency services in this manner. The sensor is, for example, a tracking transmitter which can be located by the sensor system in the motorcycle. The sensor system thereupon determines the location of the rider or passenger, possibly by using the digital map and the current position data of the motorcycle.

According to a further exemplary embodiment of the invention, the emergency call facility is constructed for fully automatically transmitting the emergency call. No intervention by the rider is required so that the emergency call can also be transmitted if, for example, the rider is unconscious.

According to a further exemplary embodiment of the invention, the detection unit exhibits a position sensor for detecting an angle of inclination of the motorcycle, an acceleration sensor for detecting an acceleration of the motorcycle, a speed sensor for detecting a speed of the motorcycle, an ABS sensor system (in order to detect braking actions) and/or a touch sensor.

It is also possible, for example, to provide spring travel sensors which detect the force with which the motorcycle is pressed onto the road. All these sensors can contribute to an accurate reconstruction of the accident or to find out whether an accident has occurred at all (or how severe the accident was) or not.

According to a further exemplary embodiment of the invention, the control unit is constructed for converting by means of a media conversion the data to be transmitted with the emergency call.

The term media conversion quite generally designates the translation, transformation or conversion of a file from one file format into another one. This applies both to the transfer of data between different media and file systems and to the transmission of data from one storage medium to another.

According to a further exemplary embodiment of the invention, the control unit, for carrying out the media conversion, is equipped with a speech synthesizer which is constructed for converting by means of speech synthesis the data to be transmitted with the emergency call.

According to a further exemplary embodiment of the invention, the receiver is a mobile terminal.

For example, the receiver can be a mobile telephone which receives the edited, media-converted emergency call data as voice information.

It is also possible that the emergency call data, as an alternative or additionally to the voice information, are sent in a text form or in the form of a video. For example, the receiver can decide whether it wishes to have the data sent as audio data, video data or in text form, e.g. as SMS. It is also possible that the receiver selects that the determined position of the motorcycle is to be transmitted in text form whereas address information (which corresponds to the determined position and has been determined with the aid of a digital map) is transmitted in voice form.

In this manner, the automated emergency call can be received by a multiplicity of mobile receivers which, if necessary, then forward the emergency call to other mobile receivers or to a center.

In addition, the receiver can be a permanently installed network access device (NAD).

According to a further exemplary embodiment of the invention, the communication link for transmitting the converted data (for example the voice information) is a narrow-band communication link. In this manner, it is also possible to use inexpensive narrow-band receiving devices such as mobile telephones.

According to a further exemplary embodiment of the invention, the emergency call contains further voice information which corresponds to an audible voice input of the rider of the motorcycle, the communication unit being constructed for transmitting all data in the same transmission channel.

It is thus possible that the motorcyclist or his passenger additionally outputs voice messages which are then transmitted by the emergency call facility. All information items are transmitted serially in the same transmission channel.

According to a further exemplary embodiment of the invention, the position finding unit is constructed for determining the position of the motorcycle on the basis of satellite data or on the basis of data from a mobile radio network.

If there is no satellite reception, the control unit can determine the position in that, for example, map matching is carried out after the control unit has determined the probable location from the last GPS position and other measurement data, for example from a distance sensor and a steering wheel angle sensor. To render this position measurement or position prognosis even more accurate, it is possible additionally to access data from a mobile radio network. In addition, the position finding can be completely based on the data from the mobile radio network.

According to a further exemplary embodiment of the invention, an emergency call system for motorcycles is specified which exhibits an emergency call facility, described above, and a receiver for receiving the emergency call emitted by the emergency call facility.

According to a further exemplary embodiment of the invention, the receiver is constructed for automatically producing a callback on reception of an emergency call if no further message from the rider of the motorcycle is received within a predetermined period of time, the receiver then initiating corresponding rescue measures (e.g. by informing emergency services). The emergency call facility in this arrangement is designed in such a manner that it can be called back and can receive this callback.

In this way, a fully automatic emergency call system is provided.

According to a further exemplary embodiment of the invention, the use of an emergency call facility, described above, in a motorcycle is specified.

According to a further exemplary embodiment of the invention, a method for transmitting an emergency call from a motorcycle is specified in which measurement data are detected, the measurement data are analyzed, a decision is made whether an accident of the motorcycle has occurred, a position of the motorcycle is determined and an emergency call is transmitted to a receiver when the analysis of the measurement data shows that an accident has occurred. In this context, the emergency call contains the determined position of the motorcycle.

In particular, the emergency call can also comprise address information (in the sense of a mailing address) to facilitate the finding of the accident-afflicted motorcycle for the emergency services. The address is determined by the control unit by using the GPS position data and the digital map.

According to a further exemplary embodiment of the invention, a program element is specified which, when it is executed on a processor, directs the processor to perform the method steps described above.

According to a further exemplary embodiment of the invention, a computer-readable medium is specified on which a program element is stored which, when it is executed on a processor, directs the processor to perform the method steps specified above.

At this point, it should be pointed out that, in the context of the present invention, GPS is representative for all global navigation satellite systems (GMSS) such as, e.g., GPS, Galileo, or GLONASS (Russia), Compass (China), IRNSS (India), etc.

The term “digital maps” is also understood to mean maps for advanced rider assistance systems without any navigation taking place.

A fundamental concept of the invention can be seen in the fact that an automated emergency call is emitted for an accident-afflicted motorcycle without requiring the intervention of the motorcyclist. For example, the emergency call is transmitted on a narrow-band voice channel. For example, it is possible that a rescuer, after receiving the emergency call, has certain questions for the motorcyclist or the control unit. In addition the rescuer himself can call up certain sensor data when he needs additional information. To find the position of the motorcyclist, the motorcyclist carries a suitable sensor which can find the position of the motorcyclist or a tracking transmitter which can be located by the control unit of the emergency call facility.

In the text which follows, preferred exemplary embodiments of the invention are described with reference to the figures.

### BRIEF DESCRIPTION OF THE DRAWINGS

FIG. 1 shows a diagrammatic representation of an emergency call facility according to an exemplary embodiment of the invention.

FIG. 2 shows a diagrammatic representation of an emergency call system according to an exemplary embodiment of the invention.

FIG. 3 shows a flow chart of a method according to an exemplary embodiment of the invention.

### DETAILED DESCRIPTION OF THE PREFERRED EMBODIMENTS

The representations in the figures are diagrammatic and not to scale.

In the description of the figures which follows, identical reference numbers are used for identical or similar elements.

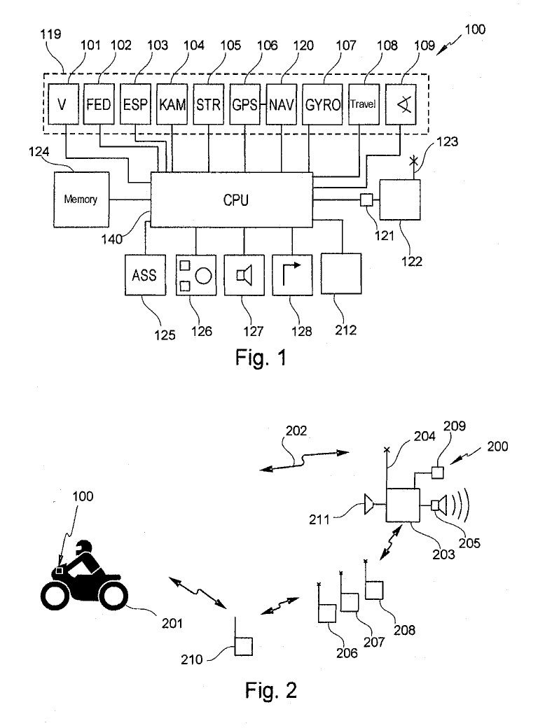

FIG. 1 shows a diagrammatic representation of components of an emergency call facility 100 for installation in a motorcycle. The emergency call facility 100 is used for transmitting an automated emergency call to a rescue operation center or also to individual mobile receivers.

The emergency call facility 100 exhibits a sensor system 119, a control unit 140 and a communication unit 122 with an antenna 123.

The data to be transmitted, which are transmitted to the communication unit 122 by the control unit 140 which, for example, is arranged in the form of a CPU, can be encrypted via an encryption facility 121. Similarly, the received data which are transmitted from the communication unit 122 to the control unit 140 can be decrypted by the encryption unit 121.

This makes it possible to reduce the risk of misuse.

An input unit 126 is connected to the control unit 140. By means of the input unit 126, various adjustments of the communication facility and possibly also of an associated navigation unit 120 can be carried out.

Furthermore, a visual output unit 128 in the form of a monitor is provided on which, for example, route guidance information can be output. In addition, the route guidance information can also be output via the audible output unit 127. The output via the audible output unit 127 has the advantage that the motorcyclist is less distracted from the current traffic situation.

Furthermore a sound input unit (see reference number 212) can also be provided. The motorcyclist and the rescuers can audibly communicate by means of the loudspeaker 127 and the sound input unit 212.

In a memory element 124 which is connected to the control unit 140 or is integrated in the control unit 140, digital map data are stored (e.g. as navigation map data) in the form of records. For example, additional information about traffic restrictions, infra-structural facilities and the like are also stored in the memory element 124 and correlated with the records.

Furthermore, a rider assistance system 125 is provided which is supplied with the digital map data or other information.

To determine the current motorcycle position, the emergency call facility 100 exhibits a navigation unit 120 with a satellite navigation receiver 106 which is designed for receiving positioning signals from, for example, Galileo satellites or GPS satellites. Naturally, the positioning unit with the satellite navigation receiver 106 can also be arranged for other satellite navigation systems.

The positioning unit 106 is connected to the control unit 140. The navigation unit 120 is also connected to the control unit 140. Furthermore, there is a direct connection between the navigation unit 120 and the positioning unit 106. The GPS signals can thus be transmitted directly to the control unit 140.

Since the positioning signals cannot always be received, for example in the inner-city area, the sensor system 119 of the emergency call facility 100 also has a direction sensor 107, a distance sensor 108, a position sensor 109, a spring travel sensor 102, an ESP sensor system 103 and possibly an optical detector 104, for example in the form of a camera, to carry out compound navigation. In addition, a beam sensor 105 (radar or lidar sensor) can be provided. The sensor system 119 also has a tachometer 101.

The signals of the GPS receiver 106 and of the other sensors are processed in the control unit 140. The vehicle position determined from these signals is matched with the road maps by map matching. In this manner, an accurate specification of the current position of the motor cycle is possible at any time.

The data provided for the transmission of the emergency call can be converted by the control unit 140, which has a speech synthesizer, into voice information by means of speech synthesis and can then be transmitted via a corresponding (voice) communication channel.

In particular the sensor system 119 is capable of delivering measurement data to the control unit 140, on the basis of which the control unit can decide precisely whether an accident has occurred or not.

Automation of the emergency call system is important since motorcyclists frequently have such severe accidents that they cannot emit their own emergency call.

From the information, for example of the position and/or acceleration sensors and the travelling speed, a possible accident can be inferred. During this process, the sensors already present on the motorcycle can be evaluated. However, it is also possible to provide sensors directly in the electronic control facility 140. It is not necessary to access airbag control devices.

In the case when an accident or fall whilst travelling has been detected, an telephonic emergency call is transmitted via the emergency call facility. In this process, the GPS data or also the data from mobile radio networks are provided for locating the motorcycle.

FIG. 2 shows a diagrammatic representation of an emergency call system according to one exemplary embodiment of the invention which exhibits an accident-afflicted motorcycle 201 with an emergency call facility 100 and a center 202 and several mobile receivers 206, 207, 208 and 210.

The center 200 exhibits a communication unit 203 in the form of a central server and an antenna 204 for transmitting and receiving data and information to and from, respectively, the accident-afflicted motorcycle or the mobile. The data are transmitted via the radio transmission link 211.

Furthermore, a loudspeaker 205 is provided via which the received voice information can be played. To play video files, a monitor 209 is provided. Voice messages can be directed to the or the motorcyclist via the microphone 211.

The center 200 is a rescue operation center which can fully automatically control the rescue operations.

For example, the center 200, after receiving the automated emergency call, transmits instructions to the individual receivers 206, 207, 208. Furthermore, the emergency call can also be transmitted directly to a single receiver 209 which then forwards this emergency call to the signal receivers 206, 207, 208 or the center 200. In this manner, the emergency call can also be effectively distributed to a multiplicity of receivers in regions with short-range reception.

According to aspects of the invention an electronic emergency call (Ecall) can be transmitted which is directly comprehensible to the rescue personnel. This requires a digital map in the motorcycle from which, by means of the GPS position, the street including the house number is determined at which the emergency call is emitted. This address is transmitted instead of or in combination with the GPS position.

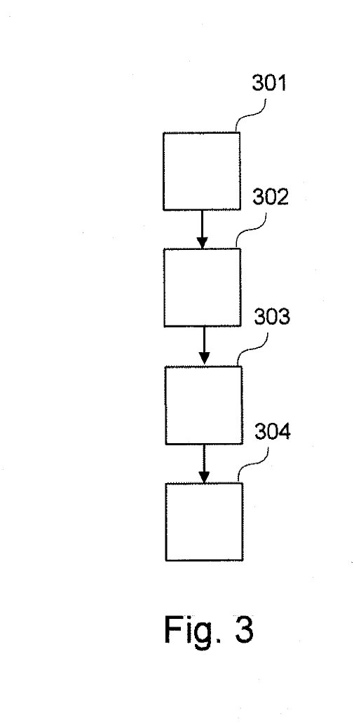

FIG. 3 shows a flow chart of a method in which in step 301, measurement data are acquired by a sensor system. In step 302, these measurement data are analyzed by a control unit and in step 303, the control unit decides by means of the analysis result whether an accident of the motorcycle has occurred or not. In the case where the analysis result shows that an accident has occurred, an emergency call is emitted in step 304 to a receiver which, among other things, exhibits the current position of the accident-afflicted motorcycle. The emergency call can be transmitted via a voice channel.

It is additionally pointed out that “comprising” and “exhibiting” does not exclude any other elements or steps and “one” or “A” does not exclude a multiplicity. Furthermore, it is pointed out that features or steps which have been described with reference to one of the above exemplary embodiments, can also be used in combination with other features or steps of other exemplary embodiments described above.

1-16. (canceled)

17. An emergency call facility for a motorcycle for transmitting an emergency call, the emergency call facility comprising:
a detection unit for detecting measurement data;
a control unit for analyzing the measurement data and for deciding whether an accident of the motorcycle has occurred;
a position finding unit for determining a position of the motorcycle;
a communication unit for transmitting an emergency call to a receiver when an analysis of the measurement data shows that an accident has occurred;
the emergency call containing the determined position of the motorcycle.

18. The emergency call facility as claimed in claim 17,
wherein the emergency call facility is configured for automatically transmitting the emergency call.

19. The emergency call facility as claimed in claim 17,
wherein the detection unit comprises at least one sensor selected from the group consisting of a position sensor for detecting an angle of inclination of the motorcycle, an acceleration sensor for detecting an acceleration of the motorcycle, and a speed sensor for detecting a speed of the motorcycle.

20. The emergency call facility as claimed in claim 17,
wherein the control unit is configured for converting data to be transmitted with the emergency call by way of a media conversion.

21. The emergency call facility as claimed in claim 20,
wherein the control unit, for carrying out the media conversion, exhibits a speech synthesizer which is configured for converting the data to be transmitted with the emergency call by way of speech synthesis.

22. The emergency call facility as claimed in claim 17,
wherein the receiver is a mobile terminal.

23. The emergency call facility as claimed claim 20,
wherein a communication link for transmitting the converted data is a narrow-band communication link.

24. The emergency call facility as claimed in claim 17,
wherein the emergency call contains further information which corresponds to an audible voice input of a rider of the motorcycle;
wherein the communication unit is configured for transmitting all data in the same transmission channel.

25. The emergency call facility as claimed in claim 20,
wherein the converted data exhibit at least one data type selected from the group consisting of video data and audio data.

26. The emergency call facility as claimed in claim 17,
wherein the position finding unit is configured for determining a position of the motorcycle on a basis of satellite data or data from a mobile radio network.

27. An emergency call system for motorcycles comprising:
an emergency call facility as claimed in claim 17; and
a receiver for receiving the emergency call emitted by the emergency call facility.

28. The emergency call system as claimed in claim 27,
wherein the receiver is configured for automatically producing a callback on reception of an emergency call if no further message from the rider of the motorcycle is received within a predetermined period of time, the receiver then initiating corresponding rescue measures;
wherein the emergency call facility is configured to receive the callback.

29. The use of an emergency call facility as claimed in claim 17 in a motorcycle.

30. A method for transmitting an emergency call from a motorcycle, the method comprising the steps of:
detecting measurement data;
analyzing the measurement data;
deciding whether an accident of the motorcycle has occurred;
determining a position of the motorcycle;
transmitting an emergency call to a receiver when an analysis of the measurement data shows that an accident has occurred, wherein the emergency call contains the determined position of the motorcycle.

31. A program element which, when it is executed on a processor, directs the processor to perform the following steps:
detecting measurement data;
analyzing the measurement data and deciding whether an accident of a motorcycle has occurred;
determining a position of the motorcycle;
transmitting an emergency call to a receiver when an analysis of the measurement data shows that an accident has occurred, wherein the emergency call contains the determined position of the motorcycle.

32. A computer-readable medium on which a program element is stored which, when it is executed on a processor, directs the processor to perform the following steps:
detecting measurement data;
analyzing the measurement data and deciding whether an accident of a motorcycle has occurred;
determining a position of the motorcycle;
transmitting an emergency call to a receiver when an analysis of the measurement data shows that an accident has occurred, wherein the emergency call contains the determined position of the motorcycle.
